(19) United States
(12) Patent Application Publication
(10) Pub. No.: US 2025/0045773 A1
(43) Pub. Date: Feb. 6, 2025

(54) SYSTEMS AND METHODS FOR MONITORING INDIVIDUAL CARBON EMISSIONS

(71) Applicant: Pahk Solutions Inc., Toronto (CA)

(72) Inventors: Tina Safaei, Toronto (CA); Foad Arvani, Toronto (CA)

(21) Appl. No.: 18/768,603

(22) Filed: Jul. 10, 2024

Related U.S. Application Data
(60) Provisional application No. 63/529,848, filed on Jul. 31, 2023.

(51) Int. Cl. G06Q 30/018

(52) U.S. Cl. CPC G06Q 30/018

(57) ABSTRACT

Methods and systems are provided for monitoring carbon emissions of an individual. The methods can involve operating at least one processor to: receive lifestyle data defining a lifestyle of the individual from a computing device; identify detectable actions based on the lifestyle data; identify electronic devices associated with the individual to generate monitoring data related to the one or more detectable actions; define monitoring parameters for the electronic devices associated with the individual; configure the one or more electronic devices to generate the monitoring data according to the one or more monitoring parameters; receive the monitoring data from the one or more electronic devices; determine a monitored carbon emission of the individual based on the monitoring data; determine a credit for the individual based on the monitored carbon emissions of the individual; and assign the credit to an account associated with the individual.

### CROSS-REFERENCE TO RELATED APPLICATIONS

This application claims the benefit of U.S. Provisional Patent Application No. 63/529,848, entitled “Systems and Method for Monitoring Individual Carbon Emissions” and filed Jul. 31, 2023, which is incorporated by reference in its entirety for all purposes.

### FIELD

The described embodiments relate to systems and methods of managing individual carbon emissions involving monitoring an individual's actions that generate carbon emissions.

### BACKGROUND

Sustainability and reduction in greenhouse gas (GHG) emissions is an increasing concern in a growing number of communities. In many jurisdictions, limits have been placed on the concentration of GHGs that can be emitted by various actors. Carbon markets and carbon credits, which allow carbon emission permits to be traded have been established to mitigate the concentration of GHGs in the atmosphere.

Carbon credit trading schemes however typically target governments and large entities and fail to account for the impact that large groups of individuals can have on the overall emissions of municipalities or organizations. Some attempts have been made to quantify individuals' carbon footprints. However, existing techniques often focus on self-reported individual actions and provide little practical use for these carbon footprint calculations. Furthermore, many individual actions can generate carbon emissions. It can be computationally intensive to gather data for each action of an individual and subsequently, to determine the overall carbon emissions of each individual based on their actions.

### SUMMARY

The various embodiments described herein generally to systems and methods of managing individual carbon emissions.

An example method of monitoring carbon emissions of an individual is disclosed herein. The method can involve operating at least one processor to: receive, from a computing device, lifestyle data defining lifestyle activities of the individual; based on the lifestyle data, identify one or more detectable actions related to at least one lifestyle activity of the individual; identify one or more electronic devices associated with the individual to generate monitoring data indicative of the one or more detectable actions. The computing device can be an electronic device of the one or more electronic devices associated with the individual. The method can further involve operating the processor to: define one or more monitoring parameters for the one or more electronic devices associated with the individual to generate the monitoring data; configure the one or more electronic devices to generate the monitoring data according to the one or more monitoring parameters; receive the monitoring data from the one or more electronic devices; determine a monitored carbon emission of the individual based at least on the monitoring data; determine a credit for the individual based at least on the monitored carbon emission of the individual; and assign the credit to an account associated with the individual.

In at least one embodiment, the monitoring parameters can include pre-processing parameters; and the method can involve operating the at least one processor to configure the one or more electronic devices to pre-process the monitoring data according to the pre-processing parameters.

In at least one embodiment, the pre-processing parameters can include one or more feature extraction parameters; and the method can involve operating the at least one processor to configure the one or more electronic devices to extract features from the monitoring data according to the one or more feature extraction parameters.

In at least one embodiment, the pre-processing parameters can include one or more pre-defined outlier thresholds; and the method can involve operating the at least one processor to configure the one or more electronic devices to discard monitoring data according to the one or more pre-defined outlier thresholds.

In at least one embodiment, the pre-processing parameters can include one or more anonymization parameters; and the method can involve operating the at least one processor to configure the one or more electronic devices to anonymize the monitoring data according to the one or more anonymization parameters.

In at least one embodiment, the one or more anonymization parameters can include one or more of a data masking parameter, a data swapping parameter, a pseudonymization parameter, a data perturbation parameter, a data generalization parameter, or a synthetic data parameter.

In at least one embodiment, operating at least one processor to determine the carbon emissions of the individual is further based on a lifecycle assessment for one or more of the lifestyle activities.

In at least one embodiment, operating the at least one processor to determine the credit for the individual based at least on the monitored carbon emission of the individual can involve operating the at least one processor to: determine at least one reference carbon emission associated with a detectable action of the one or more detectable actions; determine whether the monitored carbon emission exceeds the at least one reference carbon emission; and in response to determining that the monitored carbon emission does not exceed the at least one reference carbon emission, determine a credit for the individual based on a comparison of the monitored carbon emission to the at least one reference carbon emission.

In at least one embodiment, the method can involve operating the at least one processor to normalize each of the at least one reference carbon emission and the monitored carbon emission to a same duration prior to the comparison of the monitored carbon emission to the at least one reference carbon emission.

In at least one embodiment, the at least one reference carbon emission can include an initial carbon emission of the individual; and the method can involve operating the at least one processor to determine the initial carbon emission of the individual based on the lifestyle data.

In at least one embodiment, the monitored carbon emission can include a prior monitored carbon emission and a subsequent monitored carbon emission; and the method can involve operating the at least one processor to use the prior monitored carbon emission as a reference carbon emission of the at least one reference carbon emission.

In at least one embodiment, the at least one reference carbon emission can include a population average carbon emission associated with the detectable action.

In at least one embodiment, the at least one reference carbon emission can include an ideal carbon emission associated with each occurrence of the detectable action.

In at least one embodiment, the monitoring parameters can include one or more pre-determined sampling rates at which to generate the monitoring data.

In at least one embodiment, the one or more detectable actions can include a transportation action of the individual; and the one or more pre-determined sampling rates can include a plurality of pre-determined transportation sampling rates, each pre-determined transportation sampling rate of the plurality of transportation pre-determined sampling rates being associated with a different mode of transportation. The method can involve operating the at least one processor to configure at least one electronic device local to the individual during the transportation action to automatically use the pre-determined sampling rate associated with a mode of transportation determined by the at least one electronic device local to the individual as the sampling rate for generating the monitoring data.

In at least one embodiment, the monitoring data related to the transportation action can include movement data and speed data detected at the at least one electronic device local to the individual. The method can involve operating the at least one processor to: determine a distance traveled by the individual based on the position data and the speed data; and determine the carbon emission associated with the transportation action based on the mode of transportation and the distance traveled by the individual.

In at least one embodiment, operating the at least one processor to configure the one or more electronic devices to: determine whether the mode of transportation is stationary; and in response to determining that the mode of transportation is stationary, store the monitoring data at the at least one electronic device local to the individual; otherwise, in response to determining that the mode of transportation is non-stationary, transmit the monitoring data to the at least one processor.

In at least one embodiment, the one or more detectable actions can include an operation of an HVAC system of the individual's home; and the monitoring data related to the operation of the HVAC system can include baseline temperature data detected within the individual's home when the HVAC system is non-operational, controlled temperature data detected within the individual's home when the HVAC system is operational in accordance with the lifestyle data, and monitored temperature data detected within the individual's home following the operation of the HVAC system. The method can involve operating the at least one processor to: select a pre-defined residence model from a plurality of pre-defined residence models representative of the individual's home based at least on a comparison of the baseline temperature data and the controlled temperature data; and determine the carbon emission associated with the operation of the HVAC system of the individual's home using the pre-defined residence model and the monitored temperature data.

In at least one embodiment, the one or more detectable actions can include a food consumption action of the individual. The method can involve operating the at least one processor to: receive image data of a food item consumed by the individual; process the image data to identify the food item consumed and a quantity of the food item consumed; and determine the carbon emission associated with the food consumption action based on the food item consumed and the quantity of the food item consumed.

In at least one embodiment, the one or more detectable actions can include a waste production action of the individual. The method can involve operating the at least one processor to: receive a weight of waste produced by the individual from a first electronic device of the one or more electronic devices; receive information relating to a type of the waste produced by the individual from a second electronic device of the one or more electronic devices; and determine the carbon emission associated with the waste production action based on the weight of the waste produced and the type of the waste produced.

In at least one embodiment, the one or more detectable actions can include an energy consumption action of the individual. The method can involve operating the at least one processor to: receive energy consumption data from an electronic device of the one or more electronic devices; determine one or more energy sources for the energy based on a location of the individual; and determine the carbon emissions for the energy consumption action based on the energy consumption data and the one or more energy sources.

In at least one embodiment, the method further comprises operating the at least one processor to: receive, from the computing device, at least one request to transfer at least a portion of the credits in the account associated with the individual to an account associated with a merchant; transfer the requested credits from the account associated with the individual to the account associated with a merchant; and generate notifications to the computing device associated with the individual and a computing device associated with the merchant that the transfer is complete.

In another broad aspect, an example system for monitoring carbon emissions of one or more individuals is disclosed herein. The system can include at least one processor operable to: receive, from a computing device, lifestyle data defining lifestyle activities of an individual; based on the lifestyle data, identify one or more detectable actions related to at least one lifestyle activity of the individual; identify one or more electronic devices associated with the individual to generate monitoring data indicative of the one or more detectable actions. The computing device can be an electronic device of the one or more electronic devices associated with the individual. The at least one processor can be further operable to: define one or more monitoring parameters for the one or more electronic devices associated with the individual to generate the monitoring data; configure the one or more electronic devices to generate the monitoring data according to the one or more monitoring parameters; receive the monitoring data from the one or more electronic devices; determine a monitored carbon emission of the individual based at least on the monitoring data; determine a credit for the individual based at least on the monitored carbon emission of the individual; and assign the credit to an account associated with the individual.

In at least one embodiment, the monitoring parameters can include pre-processing parameters; and the at least one processor can be operable to configure the one or more electronic devices to pre-process the monitoring data according to the pre-processing parameters.

In at least one embodiment, the pre-processing parameters can include one or more feature extraction parameters; and the at least one processor can be operable to configure the one or more electronic devices to extract features from the monitoring data according to the one or more feature extraction parameters.

In at least one embodiment, the pre-processing parameters can include one or more pre-defined outlier thresholds; and the at least one processor can be operable to configure the one or more electronic devices to discard monitoring data according to the one or more pre-defined outlier thresholds.

In at least one embodiment, the pre-processing parameters can include one or more anonymization parameters; and the at least one processor can be operable to configure the one or more electronic devices to anonymize the monitoring data according to the one or more anonymization parameters.

In at least one embodiment, the one or more anonymization parameters can include one or more of a data masking parameter, a data swapping parameter, a pseudonymization parameter, a data perturbation parameter, a data generalization parameter, or a synthetic data parameter.

In at least one embodiment, the at least one processor can be operable to determine the carbon emissions of the individual is further based on a lifecycle assessment for at least one of the detectable actions.

In at least one embodiment, the at least one processor being operable to determine the credit for the individual based at least on the monitored carbon emission of the individual can involve the at least one processor being operable to: determine at least one reference carbon emission associated with a detectable action of the one or more detectable actions; determine whether the monitored carbon emission exceeds the at least one reference carbon emission; and in response to determining that the monitored carbon emission does not exceed the at least one reference carbon emission, determine a credit for the individual based on a comparison of the monitored carbon emission to the at least one reference carbon emission.

In at least one embodiment, the at least one processor can be operable to normalize each of the at least one reference carbon emission and the monitored carbon emission to a same duration prior to the comparison of the monitored carbon emission to the at least one reference carbon emission.

In at least one embodiment, the at least one reference carbon emission can include an initial carbon emission of the individual; and the at least one processor can be operable to determine the initial carbon emission of the individual based on the lifestyle data.

In at least one embodiment, the monitored carbon emission can include a prior monitored carbon emission and a subsequent monitored carbon emission; and the at least one processor can be operable to use the prior monitored carbon emission as a reference carbon emission of the at least one reference carbon emission.

In at least one embodiment, the at least one reference carbon emission can include a population average carbon emission associated with the detectable action.

In at least one embodiment, the at least one reference carbon emission can include an ideal carbon emission associated with each occurrence of the detectable action.

In at least one embodiment, the monitoring parameters can include one or more pre-determined sampling rates at which to generate the monitoring data.

In at least one embodiment, the one or more detectable actions can include a transportation action of the individual; and the one or more pre-determined sampling rates can include a plurality of pre-determined transportation sampling rates, each pre-determined transportation sampling rate of the plurality of transportation pre-determined sampling rates being associated with a different mode of transportation. The at least one processor can be operable to configure at least one electronic device local to the individual during the transportation action to automatically use the pre-determined sampling rate associated with a mode of transportation determined by the at least one electronic device local to the individual as the sampling rate for generating the monitoring data.

In at least one embodiment, the monitoring data related to the transportation action can include movement data and speed data detected at the at least one electronic device local to the individual. The at least one processor can be operable to: determine a distance traveled by the individual based on the movement data and the speed data; and determine the carbon emission associated with the transportation action based on the mode of transportation and the distance traveled by the individual.

In at least one embodiment, the at least one processor can be operable to configure the one or more electronic devices to: determine whether the mode of transportation is stationary; and in response to determining that the mode of transportation is stationary, store the monitoring data at the at least one electronic device local to the individual; otherwise, in response to determining that the mode of transportation is non-stationary, transmit the monitoring data to the at least one processor.

In at least one embodiment, the one or more detectable actions can include an operation of an HVAC system of the individual's home; and the monitoring data related to the operation of the HVAC system can include baseline temperature data detected within the individual's home when the HVAC system is non-operational, controlled temperature data detected within the individual's home when the HVAC system is operational in accordance with the lifestyle data, and monitored temperature data detected within the individual's home following the operation of the HVAC system. The at least one processor can be operable to: select a pre-defined residence model from a plurality of pre-defined residence models to representative of the individual's home based at least on a comparison of the baseline temperature data and the controlled temperature data; and determine the carbon emission associated with the operation of the HVAC system of the individual's home using the pre-defined residence model and the monitored temperature data.

In at least one embodiment, the one or more detectable actions can include a food consumption action of the individual. The at least one processor can be operable to: receive image data of a food item consumed by the individual; process the image data to identify the food item consumed and a quantity of the food item consumed; and determine the carbon emission associated with the food consumption action based on the food item consumed and the quantity of the food item consumed.

In at least one embodiment, the one or more detectable actions can include a waste production action of the individual. The at least one processor can be operable to: receive a weight of waste produced by the individual from a first electronic device of the one or more electronic devices; receive information relating to a type of the waste produced by the individual from a second electronic device of the one or more electronic devices; and determine the carbon emission associated with the waste production action based on the weight of the waste produced and the type of the waste produced.

In at least one embodiment, the one or more detectable actions can include an energy consumption action of the individual. The at least one processor can be operable to: receive energy consumption data from an electronic device of the one or more electronic devices; determine one or more energy sources for the energy based on a location of the individual; and determine the carbon emissions for the energy consumption action based on the energy consumption data and the one or more energy sources.

In at least one embodiment, the at least one processor can be operable to: receive, from the computing device, at least one request to transfer at least a portion of the credits in the account associated with the individual to an account associated with a merchant; transfer the requested credits from the account associated with the individual to the account associated with a merchant; and generate notifications to the computing device associated with the individual and a computing device associated with the merchant that the transfer is complete.

### BRIEF DESCRIPTION OF THE DRAWINGS

Several embodiments will now be described in detail with reference to the drawings, in which:

FIG. 1 is a block diagram of a carbon management system in communication with external components, in accordance with an example embodiment;

FIG. 2 is a block diagram of the carbon management system of FIG. 1, in communication with other external components, in accordance with an example embodiment; and

FIG. 3 is a flowchart of a method of monitoring carbon emissions of an individual, in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

The various embodiments described herein generally relate to systems and methods for monitoring carbon emissions of an individual.

Sustainability and a focus on reducing GHG emissions is becoming more prevalent in a large number of communities. In many countries, carbon trading schemes that allow businesses, organizations and governments to offset their GHG emissions have been implemented. Under these carbon trading schemes, entities that emit less GHG emissions than their allotted quota can sell or trade carbon credits, representing verified GHG reductions from removing GHGs from the atmosphere or reducing GHG emissions, to other entities. A carbon credit is a permit that allows the holder to emit a set amount of GHG into the atmosphere. These carbon credits are typically acquired by entities looking to meet voluntary climate targets or commitments, or entities that require additional allocations, for compliance with quotas set by regulators or other market operators.

Carbon credit trading schemes however typically target large entities, as the individual footprint of individuals is typically insufficient to offset the GHG emissions of large entities. However, large groups of individuals can have a significant impact on the overall GHG emissions of their communities, such as geographic communities or other organizational communities. When incentivized through rewards, individuals can undertake many actions to reduce their carbon footprint.

Although each action only yields very small reductions in one's carbon footprint, cumulatively, many actions can lead to a sizeable reduction in one's carbon footprint. However, it can be computationally intensive to calculate the reduction yielded by each action. Furthermore, significant processing power may be required to calculate the reduction yielded by many actions.

The various embodiments described herein allow for the carbon footprint of individuals to be monitored and for credits to be assigned to individuals based on their monitored carbon footprint. The various embodiments described herein can be used as part of a carbon management system that allows credits to be redeemed for goods and services and that allow a circular economy to be created between parties having sustainability goals.

The various embodiments described herein can obtain data relating to an individual's habits, analyze the data to identify actions taken by the individual and calculate GHG emissions emitted by the individual based on the actions taken by the individual to reward behaviors promoting sustainable habits. In some embodiments, the rewards can correspond to carbon credits.

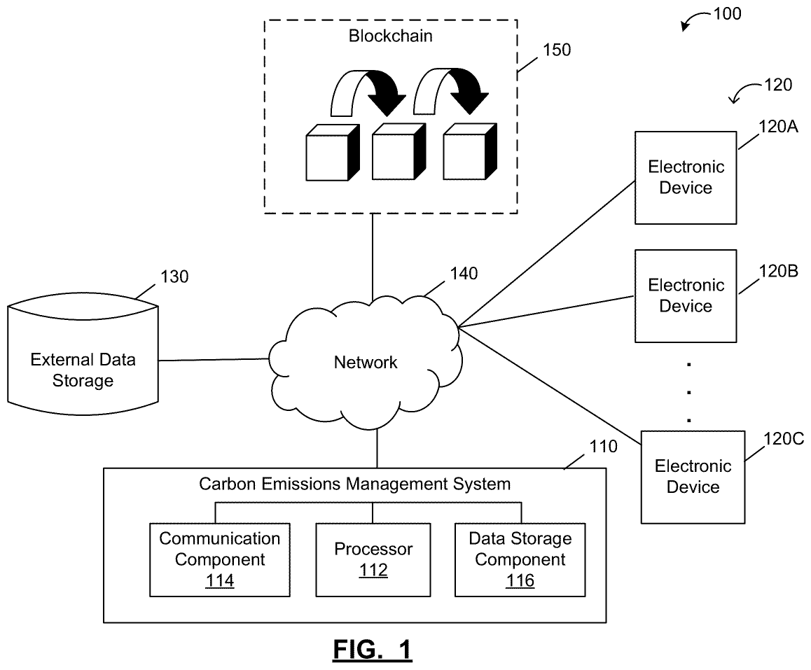

Reference is first made to FIG. 1, which shows an example block diagram 100 of a carbon emissions management system 110 in communication with external components. As shown in FIG. 1, the carbon emissions management system 110 is in communication with one or more electronic devices 120 associated with the individual and an external data storage 130 via a network 140. The carbon emissions management system 110 can additionally be in communication with a blockchain 150.

The carbon emissions management system 110 includes a processor 112, a communication component 114, and a data storage component 116. The carbon emissions management system 110 can be combined into a fewer number of components or can be separated into further components. The carbon emissions management system 110 can be provided on one or more computer servers that may be distributed over a wide geographic area and connected via the network 140. For example, the carbon emissions management system 110 can include an authentication server that ensures that unauthorized devices do not transmit data to the carbon emissions management system 110 and separate servers for each of the functions of the carbon emissions management system 110 (e.g., dedicated detectable action identification server(s), dedicated greenhouse gas emission calculation server(s), dedicated reward calculation server(s)). The authentication server can for example authenticate devices seeking to transmit data to the carbon emissions management system 110 (e.g., electronic device(s) 120) prior to the devices transmitting data to the carbon emissions management system 110.

The carbon emissions management system 110 can perform various functions related to determining the carbon footprint of an individual. For example, the carbon emissions management system 110 can receive data from the electronic devices 120 associated with the individual and/or retrieve data from the data storage component 116 and/or the external data storage 130, identify detectable actions having a carbon footprint, configure the electronic devices 120 to generate data, calculate carbon emissions (i.e., greenhouse gas (GHG) emissions) generated as a result of the detectable actions, determine credits based on the calculate GHG emissions and assign the credits to an account associated with the individual.

The processor 112 can operate to control the operation of the carbon emissions management system 110. The processor 112 can initiate and manage the operations of each of the other components within the carbon emissions management system 110. The processor 112 may be any suitable processors, controllers or digital signal processors that can provide sufficient processing power depending on the configuration, purposes and requirements of the carbon emissions management system 110. In some embodiments, the processor 112 can include more than one processor with each processor being configured to perform different dedicated tasks.

The communication component 114 can include any interface or component that enables the carbon emissions management system 110 to communicate with the electronic devices 120, the external data storage 130, and the blockchain 150 via network 140 to receive data and that enables the processor 112 to communicate with the data storage component 116.

The data storage component 116 can include RAM, ROM, one or more hard drives, one or more flash drives or some other suitable data storage elements such as disk drives, etc. Similar to the data storage component 116, the external data storage 130 can also include RAM, ROM, one or more hard drives, one or more flash drives or some other suitable data storage elements such as disk drives, etc.

The data storage component 116 can include one or more databases for storing information including algorithms relating to carbon emission calculations, detectable action identification, credit calculations and any other types of data that can be used for determining credits, including but not limited to, monitoring data and lifestyle data received from the electronic devices 120, data relating to lifecycle assessments, data relating to ideal GHG emissions, data relating to population average GHG emissions, and data relating to models that can be used to determine credits or rewards or to calculate or approximate GHG emissions.

The external data storage 130 can store similar types of data as the data storage component 116. However, the external data storage 130 can store data that is less frequently accessed than the data stored in the data storage component 116. For example, the external data storage 130 can store data received from external sources or third parties, for example, data relating to energy sources used in various locations, demographic data, data relating to flight routes, data relating to costs and GHG emissions of food items, clothing items and household items, data relating to fuel consumption, weather data and any other types of data that is used for calculating GHG emissions and determining rewards.

The electronic devices 120 can be any networked device associated with the individual and operable to connect to the network 140. A networked device is a device capable of communicating with other devices through a network such as the network 140. A networked device may couple to the network 140 through a wired or wireless connection.

The electronic devices 120 can be any type of device that can generate monitoring data. At least some of the electronic devices 120 are devices that have the processing capabilities to pre-process the monitoring data obtained. Electronic devices can include but are not limited to sensors, smart devices, Internet of Things (IoT) devices, mobile devices and cameras. While three electronic devices 120 are shown in FIG. 1, it will be understood that system 110 can be in communication with fewer or more electronic devices 120.

In some embodiments, at least one electronic device 120 can directly transmit monitoring data to the carbon emissions management system 110 via the network 140. In some embodiments, at least one electronic device 120B, 120C can be in communication with another electronic device 120A but not be in direct communication with the carbon emissions management system 110. In such embodiments, the other electronic device 120A can generate data from the at least one electronic device 120B, 120C and transmit the data to the carbon emissions management system 110.

In some cases, the electronic device 120A can pre-process the data prior to transmitting the data to the carbon emissions management system 110. For example, an electronic device 120B such as a smart thermostat may not have the processing capabilities to process data collected and/or the networking capabilities to transmit data to the carbon emissions management system 110. In such case, the smart thermostat 120B may transmit the data collected to the electronic device 120A or to another electronic device 120C with sufficient processing capabilities to pre-process the data before transmitting the pre-processed data to the carbon emissions management system 110. For example, the electronic device 120A can be a mobile device with GPS functionalities which can be used to monitor a location and speed of the individual.

At least one electronic device 120, such as electronic device 120A can be a computing device used to provide lifestyle data to the carbon emissions management system 110. The computing device 120A can include at least a processor and memory, and can be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

In some embodiments, the electronic devices 120 can include a plurality of computing devices. For example, the individual can interact with the carbon emissions management system 110 using a mobile device 120A and a personal computer 120C. Further, block diagram 100 shown in FIG. 1 shows the carbon emissions management system 110 in communication with a plurality of electronic devices 120 associated one individual. It will be understood that multiple individuals can interact with the carbon emissions management system 110 and each individual can be associated with one or more electronic devices 120.

The computing device 120A can communicate with the carbon emissions management system 110 to transmit lifestyle data to the carbon emissions management system 110. The lifestyle data transmitted can be obtained by the computing device 120A. For example, when the carbon emissions management system 110 is first used by the individual, the computing device 120A can prompt the individual associated with the computing device 120A to provide information related to the individual's lifestyle. Alternatively, or in addition thereto, the computing device 120A can automatically obtain data relating to the lifestyle of the individual. Lifestyle data can include any type of data that defines the lifestyle and/or habits of the individual and can include demographic data. For example, lifestyle data can include but is not limited to data about the number of people that reside in the individual's home, the type of home that the individual lives in (i.e., detached home, attached home, high density building, low density building, mobile home etc.), the size of the individual's home (i.e., number of bedrooms), whether the individual intentionally pays for clean energy, average annual mileage driven, vehicle fuel-type, average vehicle fuel consumption, typical alternative modes of transportation (i.e., bus, subway, intercity rail, bike, walk), average annual number of flights, average household food waste, and average shopping frequency.

The network 140 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX™), Signaling System No. 7 (SS7) signaling network, fixed line, local area network, wide area network, and others, including any combination of these, capable of interfacing with, and enabling communication between, the carbon emissions management system 110, the electronic devices 120, and the external data storage 130.

As described, the carbon emissions management system 110 can be in communication with a blockchain system 150. The blockchain system 150 can be used for example, to enhance verifiability and traceability of transactions and can be used to facilitate the transfer of credits. The blockchain system 150 can also be used for record keeping, for example, for recording credits. It will be understood that the blockchain system 150 can include a processor for processing blockchain operations.

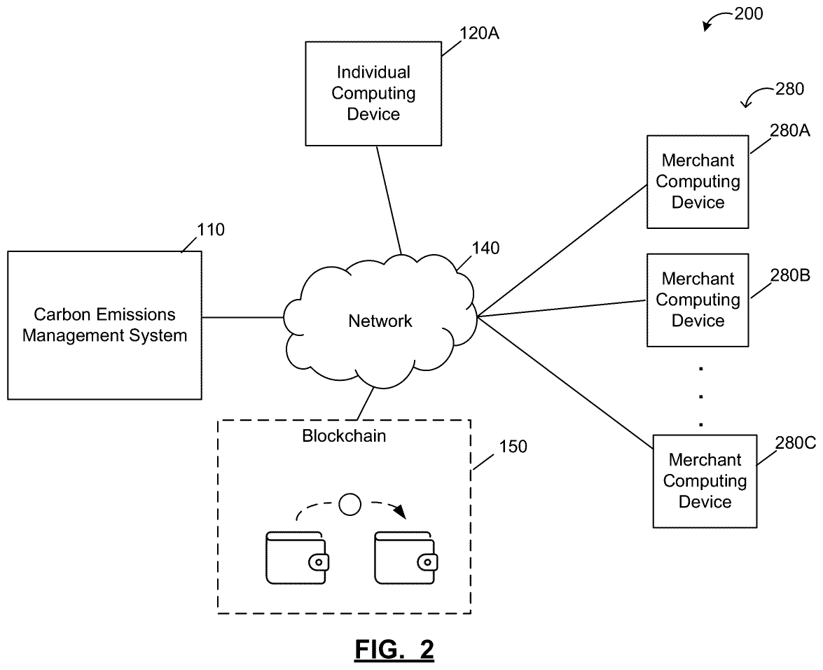

Reference is now made to FIG. 2, which shows a block diagram 200 of the carbon emissions management system 110 in communication with the computing device 120A and merchant devices 280 via the network 140. The carbon emissions management system 110 can additionally be in communication with a blockchain 150 via the network 140. As described above, the carbon emissions management system 110 can be part of a system that allows individuals to trade or redeem rewards for goods and services provided or sold by entities. The entities can for example, correspond to businesses or organizations that have an interest in the promotion of sustainable habits and/or that need or have an interest in offsetting their carbon emissions through carbon credits. Each entity can be associated with a merchant device 280. While only three merchant devices 280a-208c are shown in FIG. 2, the carbon emissions management system 110 can be in communication with fewer or more merchant devices 280.

As described with reference to FIG. 1, the carbon emissions management system 110 can determine rewards, or credits, based on monitored carbon emissions and assign credits to the individual. For example, the carbon emissions management system 110 can allocate credits to an account associated with the individual, which can be accessible to the individual via the computing device 120A. In some embodiments, the credits can be generated on a blockchain 150, in the form of cryptocurrency. For example, the carbon emissions management system 110 can generate cryptocurrency or transfer cryptocurrency from a digital wallet associated with the carbon emissions management system 110 to a digital wallet associated with the individual. For example, the computing device 120A can provide access to a digital wallet storing the rewards. Each merchant device 280 can similarly be associated with a digital wallet. When rewards are redeemed or traded in exchange for goods and/or services provided by the entities, the digital wallet associated with the individual can transfer tokens to the wallet associated with the entity providing the goods and/or services.

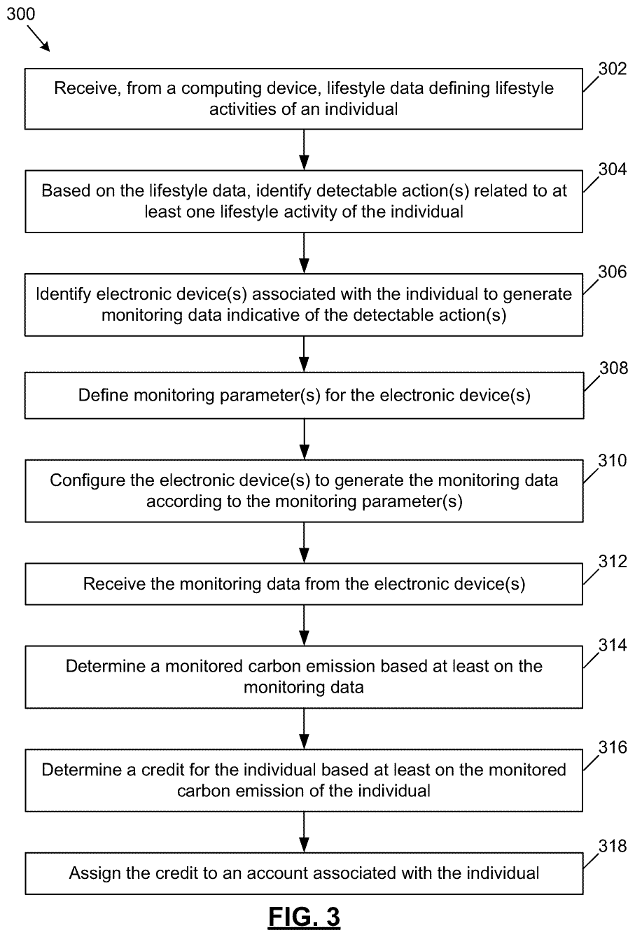

Reference is now made to FIG. 3, which shows a flowchart of an example method 300 of managing carbon emissions.

At 302, the processor 112 can receive lifestyle data from a computing device 120A. The lifestyle data can define lifestyle activities of the individual. The lifestyle data can include demographic data, data that characterizes the individual's sustainability habits, transportation data defining properties of a vehicle used by the individual and/or residential data defining properties of a residence of the individual. Example types of lifestyle data include but are not limited to the age of the individual, the type of diet of the individual, the location of the individual, the community type of the individual (e.g., urban, suburban, rural), the type of vehicle driven by the individual and the type of building in which the individual resides. The lifestyle data can be provided by the individual via the computing device 120A. For example, when the individual first uses the carbon emissions management system 110, the computing device 120A can present to the individual a questionnaire to obtain information about the individual during an onboarding process. The individual can also be prompted to update lifestyle data at a predetermined frequency (e.g., every month, every year, etc.) or when a change is detected in the individual's lifestyle, as determined by the monitoring data (described at 312). In some embodiments, at least part of the lifestyle data can be automatically obtained by the computing device 120A and transmitted to the processor 112. For example, the computing device 120A may automatically detect the location of the individual and transmit the location to the processor 112.

At 304, the processor 112 can identify detectable action(s) based on the lifestyle data received at 302. The detectable action(s) can be related to at least one lifestyle activity of the individual. The detectable action(s) can include any action related to the at least one lifestyle activity that impacts the individual's carbon emissions and that can be monitored by the electronic device(s) 120. That is, identifying detectable action(s) can involve defining monitoring data that is indicative of the detectable action(s).

For example, detectable actions can include but are not limited to, traveling from an origin to a destination (e.g., a transportation action, a travel action), setting the temperature of a residence, using energy in a residence, using water in a residence, consuming food, producing waste and purchasing food items, household items and/or clothing items. Based on the lifestyle data received at 302 for example, the processor 112 can determine that information relating to a vehicle driven by an individual is known and accordingly, the processor 112 can identify that monitoring data relating to a transport action should be obtained to calculate the GHG emissions associated with the individual's use of the individual's vehicle. As another example, based on the location of the individual, it may be determined that the individual lives in a rural area with no access to public transport. In such cases, the processor 112 can determine that transportation actions require detection of the movement of a vehicle. As another example, based on the lifestyle data received at 302, it may be determined that the individual owns a smart thermostat. In such case, the processor 112 can determine that monitoring data relating to a home temperature action can be obtained.

At 306, the processor 112 can identify electronic device(s) 120 associated with the individual to generate monitoring data indicative of the one or more detectable actions identified at 304. For example, based on the processor 112 identifying that a transport action can be identified, the processor 112 can determine that a GPS device or a mobile device can be used to generate monitoring data indicative of the transportation action. As another example, based on the processor 112 identifying that a waste production action can be identified and that the individual owns a smart waste bin, the processor 112 can determine that monitoring data indicative of the waste production action can be generated by the smart waste bin.

At 308, the processor 112 can define monitoring parameter(s) for the electronic device(s) 120 identified at 306. The monitoring parameters can include one or more pre-determined sampling rates at which to generate the monitoring data. The monitoring parameters can vary based on the type of data collected and on the electronic device(s) collecting the data. The monitoring parameters can include a detection rate at which data is collected, a sampling rate at which data is generated based on the data collected, a transmission rate at which generated data is transmitted to the processor 112, a precision level associated with the generated data, and an accuracy level associated with the generated data.

At 310, the processor 112 can configure the electronic device(s) to generate the monitoring data according to the monitoring parameter(s).

The monitoring parameters can also include parameters that determine a manner in which the data is collected and a format of the data collected. For example, for a transportation action, the monitoring parameters can include a plurality of pre-determined transportation sampling rates. Each pre-determined transportation sampling rate can be associated with a different mode of transportation. An electronic device local to the individual can determine a mode of transportation that the individual is traveling in. The processor 112 can configure the electronic device(s) to automatically use the pre-determined sampling rate associated with the detected mode of transportation as the sampling rate for generating the monitoring data. By varying the sampling rate based on the mode of transportation, the computational resources required for processing the monitoring data can be managed. In particular, lowering the sampling rate also lowers the computational resources required for determining the carbon emissions. The trade-off of a lower computation resource requirement is a lower accuracy in the carbon emissions calculation. However, depending on the mode of transportation, a lower accuracy can be an acceptable trade-off. For example, a lower sampling rate can be used when the mode of transportation is slower, such as walking, because the reduced accuracy is less significant. In contrast, a higher sampling rate can be used when the mode of transportation is faster, such as driving, to avoid a more significant reduction in accuracy.

For a transportation action, the monitoring data can include movement data and speed data. In some embodiments, different sampling rates can be used for generating both the movement data and the speed data. In some embodiments, the generation of monitoring data can be initiated based on the detection of a trigger. The trigger can be a time-based trigger or an event-based trigger.

Although the above examples relate to varying the sampling rates based on the mode of transportation, other monitoring parameters can be varied. That is, the detection rate, the transmission rate, the precision level and/or the accuracy level can be varied. For example, the processor 112 can configure the electronic device(s) to have a transmission rate that is lower than the sampling rate to reduce the communication load on the electronic device(s). As well, the precision level and/or the accuracy levels can vary depending on the type of data being generated.

In some embodiments, the processor 112 can configure the electronic device(s) to determine whether the mode of transportation is stationary. In response to determining that the mode of transportation is stationary, the electronic device(s) can store the monitoring data at the electronic device(s). Otherwise, in response to determining that the mode of transportation is non-stationary, the electronic device(s) can transmit the monitoring data to the at least one processor 112. In particular, in response to determining that the mode of transportation is no longer stationary, the electronic device(s) can begin transmitting the monitoring data to the at least one processor 112. Conversely, in response to determining that the mode of transportation has returned to stationary, the electronic device(s) can cease transmitting the monitoring data to the at least one processor 112 and begin storing the monitoring data at the electronic device(s).

In some embodiments, the monitoring parameters can include pre-processing parameters. The processor 112 can configure the electronic device(s) 120 to pre-process the monitoring data according to the pre-processing parameters.

For example, the pre-processing parameters can include feature extraction parameters. The processor 112 can configure the electronic device(s) 120 to extract features from the monitoring data. Features can be extracted from the monitoring data using any known technique for extracting features from data. For example, the data obtained from the electronic device(s) 120 can be used to construct informative, non-redundant derived values (i.e., features), which can include statistical and physical representations of the data (e.g., mean values of variables in a window, histograms of oriented gradients, etc.).

In another example, the pre-processing parameters can include one or more pre-defined outlier thresholds. The processor 112 can configure the electronic device(s) 120 to discard monitoring data according to the one or more pre-defined outlier thresholds. For example, the pre-defined outlier thresholds can include a maximum threshold and a minimum threshold. The electronic device(s) can discard monitoring data that is greater than the maximum threshold or less than the minimum threshold.

In yet another example, the pre-processing parameters can include anonymization parameters. The processor 112 can configure the electronic device(s) 120 to anonymize the monitoring data according to the one or more anonymization parameters. For example, the electronic device(s) 120 can be configured to use the anonymization parameters to anonymize the monitoring data with known techniques including but not limited to data masking, data swapping, pseudonymization, data perturbation, generalization and addition of synthetic data. Furthermore, the electronic device(s) 120 can be configured to remove or omit personally identifiable information from the monitoring data.

At 312, the processor 112 can receive monitoring data from the electronic device(s) 120.

In some embodiments, the electronic device(s) 120 can detect the detectable action(s) from the monitoring data and transmit to the carbon emissions management system 110 only data that is indicative of the detectable action(s). For example, the electronic device 120 can collect location data for example, from a GPS module of the electronic device 120 and timing data and based on the location data and the timing data, the electronic device 120 can determine the mode of transportation of the individual and the distance travelled. The monitoring data received by the processor 112 can include data indicating, for example, that the individual walked and the distance walked. Alternatively, the monitoring data received by the processor 112 can include no assessment of the detectable action(s). For example, the processor 112 can receive the distance traveled by the individual and the speed of the individual from the electronic device 120 and the processor 112 can determine the action.

In some embodiments, based on the monitoring parameters defined at 308, the electronic device(s) 120 can transmit monitoring data to the carbon emissions management system 110 only when a threshold is met and/or an event is detected. For example, the electronic device(s) 120 can monitor data and log data only when a change is detected.

For a transportation action, for example, the electronic device 120 can monitor the location of the individual until it is determined that the individual is moving. When the electronic device 120 determines that the individual is moving, the electronic device 120 can begin logging location data and timing data. The electronic device 120 can determine the distance traveled by the individual and the speed of travel of the individual and transmit this data to the carbon emissions management system 110 at the completion of the action, for example, when the electronic device 120 determines that the individual has reached the individual's destination and has stopped moving and/or when the size of the data bundle exceeds a predetermined threshold. As another example, temperature data can be obtained from a thermostat (or another electronic device 120 in communication with the thermostat) and/or a temperature sensor at predetermined intervals as determined by the monitoring parameters and can be transmitted to the carbon emissions management system 110 at predetermined time intervals and/or when the size of the data bundle exceeds a predetermined threshold, depending on the monitoring parameters.

At 314, the processor 112 can determine carbon emissions based on the monitoring data and the detectable action(s). To determine the carbon emissions, the processor 112 can determine attributes defining aspects of the detectable action(s) based on the monitoring data received at 312. For example, based on the monitoring data received, the processor 112 can determine a distance traveled by the individual, detect changes in the individual's residence's temperature settings, determine a waste level produced by the individual, determine the type and amount of food consumed by the individual, determine an energy source and usage of the individual's residence, determine that the individual is taking a flight, etc. For each detectable action, the processor 112 can, based on the monitoring data received, determine the carbon emissions associated with that action.

Returning to the example of a transportation action, the monitoring data related to the transportation action can include movement data and speed data. The processor 112 can determine a distance traveled by the individual based on the movement data; and determine the carbon emission associated with the transportation action based on the mode of transportation, as indicated by the speed data, and the distance traveled by the individual. For example, a short distance and a low speed can be indicative that the individual traveled on foot. Based on this determination, the processor 112 can determine the carbon emissions associated with walking between the two locations. Conversely, a long distance and a high speed can be indicative that the individual traveled by car. Based on this determination, the processor 112 can determine the carbon emissions associated with traveling over the distance determined using a vehicle.

In some embodiments, the carbon emissions associated with travelling using a vehicle can be further based on the lifestyle data. In particular, the lifestyle data can include data about the type of vehicle, such a fuel type used by the vehicle, and size of the vehicle.

In some embodiments, the processor 112 can correlate movement data of multiple individuals to determine whether the individual carpooled by car together. The processor 112 can divide the carbon emissions associated with traveling over the distance determined using a vehicle amongst the individuals of the carpool.

As another example, the carbon emissions management system 110 can receive temperature data obtained from a thermostat (from the thermostat or from another electronic device in communication with the thermostat) and/or from temperature sensors and based on the temperature data, the processor 112 can determine that the individual's thermostat settings have changed and calculate the carbon emissions based on the change.

As a further example, the processor 112 can receive weight measurements and/or processed image data from a smart waste bin (or another electronic device in communication with the smart waste bin) and based on the weight measurements and/or the image data, the processor 112 can determine the quantity of waste produced by the individual and/or the type of waste produced and accordingly the carbon emissions associated with the waste produced by the individual.

In some embodiments, determining the carbon emissions can involve approximating the carbon emissions, by applying a model to the monitoring data. For example, based on temperature data obtained from a thermostat (e.g., when the heating, ventilation and cooling (HVAC) system is turned off), the processor 112 can assess a building's age or perceived age or thermal behavior and approximate the carbon emissions associated with the thermostat's temperature settings. That is, the processor 112 can select a pre-defined residence model from a plurality of pre-defined residence models representative of the individual's home based on a comparison of baseline temperature data detected within the individual's home when the HVAC system is non-operational and controlled temperature data within the individual's home when the HVAC system is operational in accordance with the lifestyle data. In some embodiments, the selection of the pre-defined residence model can also be based on the geographic location of the individual's home and/or data associated with the location of the individual's home (e.g., characteristics of the individual's home based on its geographic location). The processor 112 can subsequently use the pre-defined residence model to determine the carbon emission associated with the operation of the HVAC system of the individual's home using the pre-defined residence model and monitored temperature data.

As another example, the carbon emissions management system 110 can obtain credit card or bank statements from the electronic device(s) 120 and/or images (or processed images, processed by the electronic device(s) 120) of receipts, and based on lifestyle data, the processor 112 can calculate the carbon emissions associated with the individual's purchases.

For example, based on the lifestyle data of the individual indicating that the individual has a vegan, vegetarian, pescatarian diet, or a low red meat, medium red meat or high red meat omnivorous diet, the processor 112 can determine carbon emissions associated with the individual's diet. For example, the processor 112 can generate an estimate of carbon emissions based on known carbon emissions for a standard basket of goods for a given diet and the cost of the individual's grocery purchases. The cost of the individual's grocery purchase can be determined via image processing of receipts, credit card statements, and/or bank statements. Alternatively, or in addition thereto, the processor 112 can obtain pre-processed images of a meal and using image recognition techniques, the processor 112 can identify the food items consumed by the individual, the quantity of food consumed by the individual, and accordingly calculate the carbon emissions based on the quantity and the type of food consumed.

The processor 112 can perform similar calculations lifestyle data indicating the individual's purchasing habits. The processor 112 can determine carbon emissions for clothing purchases, household item purchases, fuel purchases, etc. For example, the processor 112 can generate an estimate of the carbon emissions based on the type of item purchased, whether the items purchased are new or pre-owned, and/or the cost of the individual's purchases. The cost of the individual's purchases can be determined via image processing of receipts, credit card statements and/or bank statements.

In some embodiments, calculating the carbon emissions can involve the processor 112 obtaining data from external sources, for example publicly available sources. The sources can be determined based on the lifestyle data received at 302. For example, based on the individual's location, the carbon emissions management system 110 can determine the energy source(s) used by the individual. As another example, the carbon emissions management system 110 can obtain data from local energy companies based on the individual's location and calculate the carbon emissions based on the monitoring data received from an energy meter and data from local energy companies. As another example, based on credit card statements, bank statements and/or flight confirmations, the processor 112 can determine that the individual reserved a flight and based on location data obtained from the electronic device 120, the processor 112 can determine that the individual is embarking on the flight, and based on information about the duration of the flight, the distance and the type of aircraft, obtained from external sources, the processor 112 can calculate the carbon emissions associated with the individual's flight.

In some embodiments, calculating the carbon emissions can correlate the monitoring data associated with the individual with monitoring data obtained from one or more other individuals. For example, by comparing transportation data (e.g., distance traveled, travel speed, timing information) obtained from electronic device(s) 120 associated with two individuals, the processor 112 may determine that the two individuals shared a vehicle and calculate the carbon emissions of each individual to account for carpooling.

In some embodiments, calculating the carbon emissions can involve the processor 112 performing a lifecycle assessment of one or more of the detectable actions to determine the impact of the detectable action over time. For example, upon detection of a transportation action and determination that the individual cycled between two locations, the processor 112 can simulate the overall carbon emissions involved in the production of the bicycle, the use of a bicycle over the lifetime of the bicycle, the increase in food consumption associated with the use of a bicycle instead of a vehicle, etc. The lifecycle assessment can be performed using methods known in the art for performing lifecycle assessments.

The processor 112 can use any combination of the techniques described to calculate the carbon emissions. For example, the processor 112 can use a combination of temperature data obtained from a thermostat and data relating to fan and actuator running times, the type of residence of the individual, as determined based on location data and data obtained from city maps obtained from external sources to determine the thermal behavior of the building. Based on the thermal behavior of the building, the processor 112 can assess the energy efficiency of the building and approximate the carbon emissions of the residence based on the energy efficiency of the building and the data obtained from the electronic device(s) 120.

In the example of a purchase action, the monitoring parameters can include instructions for collecting data when an image of a receipt or credit card statement is captured by the electronic device 120. As another example, for an energy consumption action, the monitoring parameters can include instructions for collecting data at fixed intervals of time (e.g., every hour, at specific times of the day, once a day, etc.). The use of monitoring parameters can limit the quantity of data transmitted to the carbon emissions management system 110 and/or the frequency at which the data is transmitted, which can reduce the quantity of data processed by the carbon emissions management system 110.

At 316, the processor 112 can determine a credit for the individual based at least on the monitored carbon emission of the individual determined at 314. In some embodiments, the credits can relate to other reward metrics, such as points, scores, or carbon credits. The credits can be determined for each detectable action. For example, changes in the individual's diet that lead to a reduction in carbon emissions can be rewarded. As another example, the individual's use of public transportation can be rewarded. In determining the credits, the processor 112 can determine changes in the individual's sustainability habits, evaluate the individual's sustainability habits relative to one or more of ideal sustainability habits (i.e., an ideal carbon emission associated with an action), habits of other individuals within or outside of the individual's community (i.e., population average carbon emission), or the individual prior habits.

For example, in some embodiments, the processor 112 can determine at least one reference carbon emission associated with a detectable action. In some embodiments, the reference carbon emission can be an initial carbon emission of the individual. For example, the processor 112 can determine the initial carbon emission of the individual based on the lifestyle data. In some embodiments, the reference carbon emission can be a prior carbon emission of the individual. The processor 112 can determine monitored carbon emission of the individual based on monitoring data iteratively. In a subsequent iteration, the processor 112 can use a prior monitored carbon emission as the reference carbon emission.

The processor 112 can determine whether the monitored carbon emission determined at 314 exceeds the at least one reference carbon emission. In response to determining that the monitored carbon emission does not exceed the at least one reference carbon emission, the processor 112 can determine a credit for the individual based on a comparison of the monitored carbon emission to the at least one reference carbon emission. If the processor 112 determines that the monitored carbon emissions of the individual is less than a prior monitored carbon emission, this may suggest that the individual has adopted behaviors or habits that decrease the individual's carbon emissions. Accordingly, the carbon emissions management system 110 can reward the individual by determining credits for the individual.

In some embodiments, the processor 112 can retrieve the ideal carbon emission associated with an action or a population average carbon emission from a database, such as external data storage 130, to use as the reference carbon emission. The population average carbon emission relates to the community's average carbon emission. In such cases, the processor 112 can assign rewards to the individual if the monitored carbon emission is less than the population average carbon emission. By comparing the monitored carbon emission to the population average carbon emission or the ideal carbon emission, the individual can be rewarded even if the individual's carbon emissions are not decreasing overtime.

In some embodiments, the processor 112 can select the ideal carbon emission or the population average based on lifestyle data. For example, lifestyle data can relate to demographic data, and the ideal carbon emission or the population average carbon emission can depend on different demographics. An individual belonging to a particular demographic group that is unlikely to use a bicycle as a mode of transportation may receive more credits for using a bicycle than an individual belonging to a demographic group that is more likely to use a bicycle.

In another example, an individual residing in an area in which bicycles are rarely used as a mode of transportation may receive more credits for using a bicycle than an individual residing in an area in which bicycles are widely used as a mode of transportation.

In some embodiments, the processor 112 can normalize each of the at least one reference carbon emission and the monitored carbon emission to a same normalization duration prior to the comparison of the monitored carbon emission to the at least one reference carbon emission. That is, the processor 112 can normalize the at least one reference carbon emission and the monitored carbon emission to ensure that they relate to a similar length of time or period.

The normalization duration can be any length of time over which data about the detectable action can be obtained. In some embodiments, the normalization duration can be selected based on the detectable action that it relates to. In some embodiments, normalization can involve the processor 112 determining the monitored carbon emission for a first portion of the normalization duration, storing the monitored carbon emission for the first portion, and determining the monitored carbon emission for a remaining portion of the normalization duration, and determining the total monitored carbon emission for the entire normalization duration. The length of the first portion can be equal or unequal to the length of the remaining portion. In some embodiments, the normalization duration can include more than two duration portions. Each duration portion can be any length of time over which a change in the carbon emissions calculated can be detected. Each duration portion can correspond to any length of time over which the individual's behaviors can change (e.g., a week, a month, a season, a year, etc.).

In some embodiments, the processor 112 can determine credits based on environmental factors, such as seasonality or weather. The use of a bicycle during the summer or on a sunny day may receive less rewards than the use of a bicycle in the winter or on a rainy day. To determine environmental factors, the processor 112 can obtain data from the electronic device(s) 120, from publicly available sources and/or third party sources. For example, when transmitting monitoring data, the electronic device(s) can include weather data.

At 318, the processor 112 can assign the credits determined at 316 to the individual. For example, the processor 112 can assign credits to a user account associated with the individual. In some embodiments, the processor 112 can generate the credits on a blockchain as cryptocurrency and can transmit the cryptocurrency to a wallet belonging to the individual. For example, during the onboarding process, the individual can create a digital wallet or connect an existing digital wallet to the platform and the processor 112 may transmit the cryptocurrency to the wallet of the individual.

The carbon emissions management system can also allow for trading of the credits in exchange for goods and/or services. As described with reference to FIG. 2, when redeeming rewards for example, at least a portion of the rewards contained in the wallet or account associated with the individual can be transferred to a merchant wallet or account. In embodiments where the rewards are in the form of cryptocurrency for example, the cryptocurrency can be sent from the individual's wallet to a merchant wallet.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims. Also, in the various user interfaces illustrated in the drawings, it will be understood that the illustrated user interface text and controls are provided as examples only and are not meant to be limiting. Other suitable user interface elements may be possible.

1. A method of monitoring carbon emissions of an individual comprising operating at least one processor to:
receive, from a computing device, lifestyle data defining lifestyle activities of the individual;
based on the lifestyle data, identify one or more detectable actions related to at least one lifestyle activity of the individual;
identify one or more electronic devices associated with the individual to generate monitoring data indicative of the one or more detectable actions, the computing device being an electronic device of the one or more electronic devices associated with the individual;
define one or more monitoring parameters for the one or more electronic devices associated with the individual to generate the monitoring data;
configure the one or more electronic devices to generate the monitoring data according to the one or more monitoring parameters;
receive the monitoring data from the one or more electronic devices;
determine a monitored carbon emission of the individual based at least on the monitoring data;
determine a credit for the individual based at least on the monitored carbon emission of the individual; and
assign the credit to an account associated with the individual.

2. The method of claim 1, wherein:
the monitoring parameters comprise pre-processing parameters; and
the method comprises operating the at least one processor to configure the one or more electronic devices to pre-process the monitoring data according to the pre-processing parameters.

3. The method of claim 2, wherein:
the pre-processing parameters comprise one or more feature extraction parameters; and
the method comprises operating the at least one processor to configure the one or more electronic devices to extract features from the monitoring data according to the one or more feature extraction parameters.

4. The method of claim 2, wherein:
the pre-processing parameters comprise one or more pre-defined outlier thresholds; and
the method comprises operating the at least one processor to configure the one or more electronic devices to discard monitoring data according to the one or more pre-defined outlier thresholds.

5. The method of claim 2, wherein:
the pre-processing parameters comprise one or more anonymization parameters; and
the method comprises operating the at least one processor to configure the one or more electronic devices to anonymize the monitoring data according to the one or more anonymization parameters.

6. The method of claim 5, wherein the one or more anonymization parameters comprise one or more of a data masking parameter, a data swapping parameter, a pseudonymization parameter, a data perturbation parameter, a data generalization parameter, or a synthetic data parameter.

7. The method of claim 1, wherein operating at least one processor to determine the carbon emissions of the individual is further based on a lifecycle assessment for one or more of the lifestyle activities.

8. The method of claim 7, wherein
operating the at least one processor to determine the credit for the individual based at least on the monitored carbon emission of the individual comprises operating the at least one processor to:
determine at least one reference carbon emission associated with a detectable action of the one or more detectable actions;
determine whether the monitored carbon emission exceeds the at least one reference carbon emission; and
in response to determining that the monitored carbon emission does not exceed the at least one reference carbon emission, determine a credit for the individual based on a comparison of the monitored carbon emission to the at least one reference carbon emission.

9. The method of claim 8 comprises operating the at least one processor to normalize each of the at least one reference carbon emission and the monitored carbon emission to a same duration prior to the comparison of the monitored carbon emission to the at least one reference carbon emission.

10. The method of claim 8, wherein:
the at least one reference carbon emission comprises an initial carbon emission of the individual; and
the method comprises operating the at least one processor to determine the initial carbon emission of the individual based on the lifestyle data.

11. The method of claim 10, wherein:
the monitored carbon emission comprises a prior monitored carbon emission and a subsequent monitored carbon emission; and
the method comprises operating the at least one processor to use the prior monitored carbon emission as a reference carbon emission of the at least one reference carbon emission.

12. The method of claim 8, wherein the at least one reference carbon emission comprises a population average carbon emission associated with the detectable action.

13. The method of claim 8, wherein the at least one reference carbon emission comprises an ideal carbon emission associated with each occurrence of the detectable action.

14. The method of claim 1, wherein the monitoring parameters comprise one or more pre-determined sampling rates at which to generate the monitoring data.

15. The method of claim 14, wherein:
the one or more detectable actions comprise a transportation action of the individual;
the one or more pre-determined sampling rates comprise a plurality of pre-determined transportation sampling rates, each pre-determined transportation sampling rate of the plurality of transportation pre-determined sampling rates being associated with a different mode of transportation; and
the method comprises operating the at least one processor to configure at least one electronic device local to the individual during the transportation action to automatically use the pre-determined sampling rate associated with a mode of transportation determined by the at least one electronic device local to the individual as the sampling rate for generating the monitoring data.

16. The method of claim 15, wherein:
the monitoring data related to the transportation action comprises movement data and speed data detected at the at least one electronic device local to the individual; and
the method comprises operating the at least one processor to:
determine a distance traveled by the individual based on the position data and the speed data; and
determine the carbon emission associated with the transportation action based on the mode of transportation and the distance traveled by the individual.

17. The method of claim 15 comprises operating the at least one processor to configure the one or more electronic devices to:
determine whether the mode of transportation is stationary; and
in response to determining that the mode of transportation is stationary, store the monitoring data at the at least one electronic device local to the individual;
otherwise, in response to determining that the mode of transportation is non-stationary, transmit the monitoring data to the at least one processor.

18. The method of claim 1, wherein:
the one or more detectable actions comprise an operation of an HVAC system of the individual's home;
the monitoring data related to the operation of the HVAC system comprises baseline temperature data detected within the individual's home when the HVAC system is non-operational, controlled temperature data detected within the individual's home when the HVAC system is operational in accordance with the lifestyle data, and monitored temperature data detected within the individual's home following the operation of the HVAC system; and
the method comprises operating the at least one processor to:
select a pre-defined residence model from a plurality of pre-defined residence models representative of the individual's home based at least on a comparison of the baseline temperature data and the controlled temperature data; and
determine the carbon emission associated with the operation of the HVAC system of the individual's home using the pre-defined residence model and the monitored temperature data.

19. The method of claim 1, wherein:
the one or more detectable actions comprise a food consumption action of the individual; and
the method comprises operating the at least one processor to:
receive image data of a food item consumed by the individual;
process the image data to identify the food item consumed and a quantity of the food item consumed; and
determine the carbon emission associated with the food consumption action based on the food item consumed and the quantity of the food item consumed.

20. The method of claim 1, wherein:
the one or more detectable actions comprise a waste production action of the individual; and
the method comprises operating the at least one processor to:
receive a weight of waste produced by the individual from a first electronic device of the one or more electronic devices;
receive information relating to a type of the waste produced by the individual from a second electronic device of the one or more electronic devices; and
determine the carbon emission associated with the waste production action based on the weight of the waste produced and the type of the waste produced.

21. The method of claim 1, wherein:
the one or more detectable actions comprise an energy consumption action of the individual; and
the method comprises operating the at least one processor to:
receive energy consumption data from an electronic device of the one or more electronic devices;
determine one or more energy sources for the energy based on a location of the individual; and
determine the carbon emissions for the energy consumption action based on the energy consumption data and the one or more energy sources.

22. The method of claim 1, further comprises operating the at least one processor to:
receive, from the computing device, at least one request to transfer at least a portion of the credits in the account associated with the individual to an account associated with a merchant;
transfer the requested credits from the account associated with the individual to the account associated with a merchant; and
generate notifications to the computing device associated with the individual and a computing device associated with the merchant that the transfer is complete.

23. A system for monitoring carbon emissions of one or more individuals comprising:
at least one processor operable to:
receive, from a computing device, lifestyle data defining lifestyle activities of an individual;
based on the lifestyle data, identify one or more detectable actions related to at least one lifestyle activity of the individual;
identify one or more electronic devices associated with the individual to generate monitoring data indicative of the one or more detectable actions, the computing device being an electronic device of the one or more electronic devices associated with the individual;
define one or more monitoring parameters for the one or more electronic devices associated with the individual to generate the monitoring data;
configure the one or more electronic devices to generate the monitoring data according to the one or more monitoring parameters;
receive the monitoring data from the one or more electronic devices;
determine a monitored carbon emission of the individual based at least on the monitoring data;
determine a credit for the individual based at least on the monitored carbon emission of the individual; and
assign the credit to an account associated with the individual.

24. The system of claim 23, wherein:
the monitoring parameters comprise pre-processing parameters; and
the at least one processor is operable to configure the one or more electronic devices to pre-process the monitoring data according to the pre-processing parameters.

25. The system of claim 24, wherein:
the pre-processing parameters comprise one or more feature extraction parameters; and
the at least one processor is operable to configure the one or more electronic devices to extract features from the monitoring data according to the one or more feature extraction parameters.

26. The system of claim 24, wherein:
the pre-processing parameters comprise one or more pre-defined outlier thresholds; and
the at least one processor is operable to configure the one or more electronic devices to discard monitoring data according to the one or more pre-defined outlier thresholds.

27. The system of claim 24, wherein:
the pre-processing parameters comprise one or more anonymization parameters; and
the at least one processor is operable to configure the one or more electronic devices to anonymize the monitoring data according to the one or more anonymization parameters.

28. The system of claim 27, wherein the one or more anonymization parameters comprise one or more of a data masking parameter, a data swapping parameter, a pseudonymization parameter, a data perturbation parameter, a data generalization parameter, or a synthetic data parameter.

29. (canceled)

30. The system of claim 23, wherein the at least one processor being operable to determine the credit for the individual based at least on the monitored carbon emission of the individual comprises the at least one processor being operable to:
determine at least one reference carbon emission associated with a detectable action of the one or more detectable actions;
determine whether the monitored carbon emission exceeds the at least one reference carbon emission; and
in response to determining that the monitored carbon emission does not exceed the at least one reference carbon emission, determine a credit for the individual based on a comparison of the monitored carbon emission to the at least one reference carbon emission.

31.-43. (canceled)

44. The system of claim 23, wherein the at least one processor is operable to:
receive, from the computing device, at least one request to transfer at least a portion of the credits in the account associated with the individual to an account associated with a merchant;
transfer the requested credits from the account associated with the individual to the account associated with a merchant; and
generate notifications to the computing device associated with the individual and a computing device associated with the merchant that the transfer is complete.
